(19) United States
(12) Patent Application Publication
(10) Pub. No.: US 2006/0005316 A1
(43) Pub. Date: Jan. 12, 2006

(54) Carbonated cleaning composition and method of use

(76) Inventor: Edward E. Durrant, Providence, UT (US)

Correspondence Address: Michael W. Starkweather, 9035 S 1300 E, Suite 200, Sandy, UT, 84094, US

(21) Appl. No.: 10/886,196

(22) Filed: Jul. 7, 2004

(51) Int. Cl. C11D 3/00

(52) U.S. Cl. 8/115.51

(57) ABSTRACT

Carpeting, upholstery, drapery and other textile fibers are cleaned by applying to the fibers an aqueous, chemically carbonated cleaning solution prepared by mixing a carbonate salt and a low soluble acid with hot water, such that the low soluble acid delayedly reacts with the carbonate salt to produce carbon dioxide before being applied to the textile fibers. The delayed production of carbon dioxide helps prevent the loss of carbon dioxide before the carbon dioxide is lost. The hot water increases cleaning capability of the cleaning solution.

### BACKGROUND OF THE INVENTION

1. The Field of the Invention

This invention relates to carbonated compositions for cleaning textile fibers. More particularly this invention relates to carbonated compositions containing carbonate salt and an acid with a low solubility for delaying the production of carbon dioxide.

2. The Relevant Art

There are innumerable cleaning compositions for cleaning textile fibers such as carpets, upholstery, drapery, and the like. Each type of cleaning composition is formulated to loosen and disperse the soil from the textile fibers either physically or by chemical reaction. The soil can then be solubilized or suspended in such a manner that it can be removed from the fibers being cleaned.

Most of these cleaningcompositions are based on soaps or detergents, both of which are generically referred to as “surfactants”. By “detergent” is meant a synthetic amphipathic molecule having a large non-polar hydrocarbon end that is oil-soluble and a polar end that is water soluble. “Soap” is also an amphipathic molecule made up of an alkali salt, or mixture of salts, of long-chain fatty acids wherein the acid end is polar or hydrophilic and the fatty acid chain is non-polar or hydrophobic. Detergents are further classified as non-ionic, anionic, or cationic. Anionic or nonionic detergents are the most common.

These surfactants function because the hydrophobic ends of the molecules coat or adhere to the surface of soils and oils and the water soluble hydrophilic (polar) ends are soluble in water and help to solubilize or disperse the soils and oils in an aqueous environment.

There are several problems associated with the use of surfactants for cleaning fibers, such as carpeting and upholstery. First, large amounts of water are generally required to remove the surfactants and suspended or dissolved particles. This leads to long drying times and susceptibility to mildew. Second, surfactants generally leave an oily hydrophobic coating on the fiber surface. The inherent oily nature of the hydrophobic end of the surfactants causes premature resoiling even when the surfaces have a surfactant coating which is only a molecule thick. Third, surfactants can sometimes cause irritation or allergic reactions in people who are sensitive to these chemicals. Fourth, several environmental problems are associated with the use of soaps and detergents; some are non-biodegradable and some contain excessive amounts of phosphates, which are also environmentally undesirable.

In an attempt to solve at least some of these problems, numerous cleaning compositions have been developed. A significant improvement in the art of cleaning textile fibers, and carpets and upholstery teaches that when detergent solutions are carbonated and applied to the fibers, the solution rapidly penetrates the fibers and, through the effervescent action of the carbonation, quickly lifts the suspended soil and oil particles to the surface of the fiber from which they can be removed by vacuuming or transfer to an absorptive surface. Moreover, effervescent action requires less soap or other surfactant applied to the fibers. Because less soap or other surfactant is needed, less water is needed to affect the cleaning, and therefore, the fibers dry more rapidly than do fibers treated with conventional steam cleaning or washing applications, and little residue is left on the fibers. This results in less resoiling due to the reduced residue and a decreased likelihood of brown out because of the more rapid drying of the fibers. Although this effervescent action process is clearly advantageous over prior art methods, it still requires the use of some surfactant and, in some instances, added phosphates, which are undesirable in today's environmentally conscious society.

Generally, carbon dioxide, and thus the carbonation, is created by mixing a powdered carbonate with an acid. Because gases, including carbon dioxide, are much less soluble in hot water than cold water, it has generally been advised to mix the cleaning solution (the powdered product, which is powdered carbonate and powdered acid) in cold water to help preserve higher levels of carbonation in the cleaning solution. It is between the mixing of the powdered product with water, and before the container containing the mixture is capped, that some of the carbon dioxide is released and lost into the surrounding atmosphere. If hot water is used to make the cleaning solution, an even greater amount of carbon dioxide can escape before the lid is secured. On the other hand, cleaning solutions generally clean more effectively when they are at elevated temperatures.

Accordingly systems have been created, which hold the acid and carbonate salt in separate reservoirs and individually heat the solutions before being combined into a third container, or before being sprayed onto the textile. The result is a complex and expensive system requiring numerous reservoirs, valves, nozzles, hoses, solutions, etc.

Thus, it can be clearly recognized that there is a need for a cleaning composition formulated in a single reservoir with hot water, carbonate salt, and an acid with low solubility, which produces a delayed high level of carbonation for an extended period of time.

### SUMMARY OF THE INVENTION

The various elements of the present invention have been developed in response to the present state of the art, and in particular, in response to the problems and needs in the art that have not yet been fully solved by currently available cleaning compositions. Accordingly, the present invention provides an improved internally carbonated cleaning solution using an acid with low water solubility.

More particularly, the present invention relates to an internally carbonated aqueous cleaning composition for textiles comprising about 20 to 60%, in percent by weight, of at least one carbonate salt, about 20 to 60%, in percent by weight, of at least one acid, the acid having a solubility less than two grams per 100 grams of water at about twenty five degrees Celsius. An aqueous medium is added to the carbonate salt and the acid to produce carbon dioxide.

In another embodiment, the composition comprises about 40 to 60% of the acid and about 35 to 50% of the carbonate salt.

In one embodiment, the solid acid is either fumaric acid or adipic acid.

In another embodiment, the carbonate salt is selected from the group consisting of sodium carbonate, sodium percarbonate, sodium bicarbonate, lithium carbonate, lithium percarbonate, lithium bicarbonate, potassium carbonate, potassium percarbonate, potassium bicarbonate, ammonium carbonate, sodium sesquicarbonate, potassium sesquicarbonate, lithium sesquicarbonate, and ammonium sesquicarbonate, and ammonium bicarbonate, or any other effective carbonate salt.

In another embodiment, the aqueous medium is added to the carbonate salt and the acid at a temperature above thirty two degrees Celsius.

In another embodiment, when the composition is mixed with the aqueous medium to form a solution, the composition concentration resulting from the carbonate salt and acid in the solution is between about 0.5 to 3%.

In another embodiment, the present invention relates to a method of cleaning textile fibers comprising the steps of applying to the fibers, an internally-carbonating cleaning composition, the composition being prepared by admixing 20 to 60%, in percent by weight, a carbonate salt and 20 to 60%, in percent by weight, an acid with a solubility less than two grams per 100 grams of water at twenty five degrees Celsius, and wherein when the carbonate salt and the acid are mixed in an aqueous medium, the carbonate salt and acid react to produce carbon dioxide.

Additional features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a comparison graph showing the response of carbon dioxide production versus time for fumaric and citric acid; and

FIG. 2 illustrates a comparison graph showing the response of carbon dioxide production versus time for fumaric and tartaric acid.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In a first embodiment, a solid acid and carbonate salt are prepared and admixed in a single container and then diluted with a desired amount of water. The carbonate salt may be any one of, or a combination of the group consisting of sodium carbonate, sodium percarbonate, sodium bicarbonate, lithium carbonate, lithium percarbonate, lithium bicarbonate, potassium carbonate, potassium percarbonate, potassium bicarbonate, ammonium carbonate, sodium sesquicarbonate, potassium sesquicarbonate, lithium sesquicarbonate, and ammonium sesquicarbonate, and ammonium bicarbonate, or any other effective carbonate salt. The solid acid, preferably, has a low solubility, with a maximum solubility of approximately two grams of acid per one hundred grams of water at twenty five degrees Celsius. Examples of solid acids with low solubility include Fumaric acid, with a solubility of 0.63 grams per one hundred grams of water at twenty five degrees Celsius, and Adipic acid, with a solubility of about 1.44 grams per one hundred grams of water at twenty five degrees Celsius. Other solid acids with low solubility will also work.

The solid acids and carbonate salts are mixed or ground together to form a solid mixture. The solid mixture contains from about 20% to 60% carbonate salts and about 20% to 60% of a natural solid acid with a low solubility. The most preferable mixture contains 35% to 50% carbonate salt and 40% to 60% acid.

Additionally, in a preferred embodiment, the water temperature exceeds forty eight degrees Celsius. However, it is recognized that the water temperature may be as low as room temperature. Preferably, the temperature is not below thirty two degrees Celsius as the time for the acid to mix with the water may be excessively long. When the water is added to the solid mixture of acid and carbonate salt, the ingredients react to form the carbon dioxide, which creates effervescent bubbles.

The solution is preferably applied to the textiles as a spray; however, other known methods of applying the solution may be used. When sprayed, for example, through a wand from a pressurized container, the pressure is released when the solution is exposed to the atmosphere, and the carbonated cleaning solution breaks into a myriad of tiny effervescent bubbles.

The combined carbonation action and the cleaning solution results in a low water volume. Specifically, the soils or oil on the fibers being cleaned are surrounded by a complex of carbon dioxide bubbles and polar and non-polar ended molecules that bind with and suspend the soil. The cleaning solution then can be lifted from the fibers into the surrounding carbonating aqueous environment. By “aqueous” it is meant that there is a certain amount of water, but that does not suggest that copious amounts of water are present. In fact, it has been found that only a slight dampening of the fiber may be sufficient to promote the lifting action of the effervescent carbonated solution to loosen or dislodge the soil or oil particles from the fiber. Additionally, it has been found that the active salts, created by the carbonate/bicarbonate mix, and carbon dioxide interactive substance or complex, hold the soil particles in suspension for a time sufficient for them to be removed from the fiber by means of vacuuming or adsorption onto a textile pad, toweling or similar adsorbent material.

Typically, the acid, carbonate salt, and water ingredients are mixed in a single container. Advantageously, because the acid has a low solubility, the creation of carbonation is delayed longer than high solubility acids. This delayed carbonation provides the user with sufficient time to mix the ingredients together and seal the container before any considerable amount of the carbonation is lost to the atmosphere.

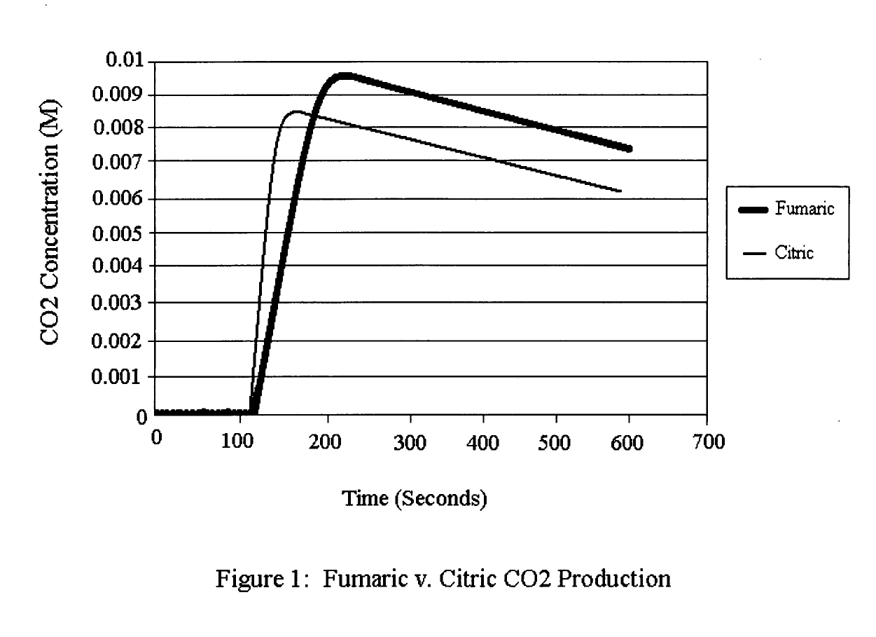

FIG. 1 illustrates a comparison graph showing the response time of carbon dioxide production for fumaric and citric acid. To quantify these results, a sample of carbonate salt solution was prepared at a concentration of 0.01 Molar and at 120 degrees Fahrenheit. A carbon dioxide ion selective electrode (previously calibrated at 120 degrees Fahrenheit) was placed in the solution and initial readings were taken for about one hundred seconds. In the first test, an effective amount of citric acid crystals, (0.0067 Molar citrate solution, enough to neutralize all of the carbonate salt solution) were mixed with the carbonate salt solution. The carbon dioxide electrode began to detect carbon dioxide almost immediately after mixture. As illustrated, the carbon dioxide reached a maximum concentration of 0.0082 Molar within about forty five seconds of adding the acid. The carbon dioxide level then began to drop after holding a maximum concentration for about fifteen seconds.

The previous experiment was repeated using a sample of fumaric acid. An effective amount of fumaric acid was mixed with a sample of carbonate salt solution, which was at a concentration of 0.01 Molar and at 120 degrees Fahrenheit. As shown in the figure, the initial production of carbon dioxide was delayed slightly when compared to the production of carbon dioxide for citric acid. The carbon dioxide reached a maximum concentration of 0.0095 Molar within about 120 seconds of mixing. The carbon dioxide level then began to drop after holding a maximum concentration for about thirty seconds, approximately twice as long as the reaction with citric acid.

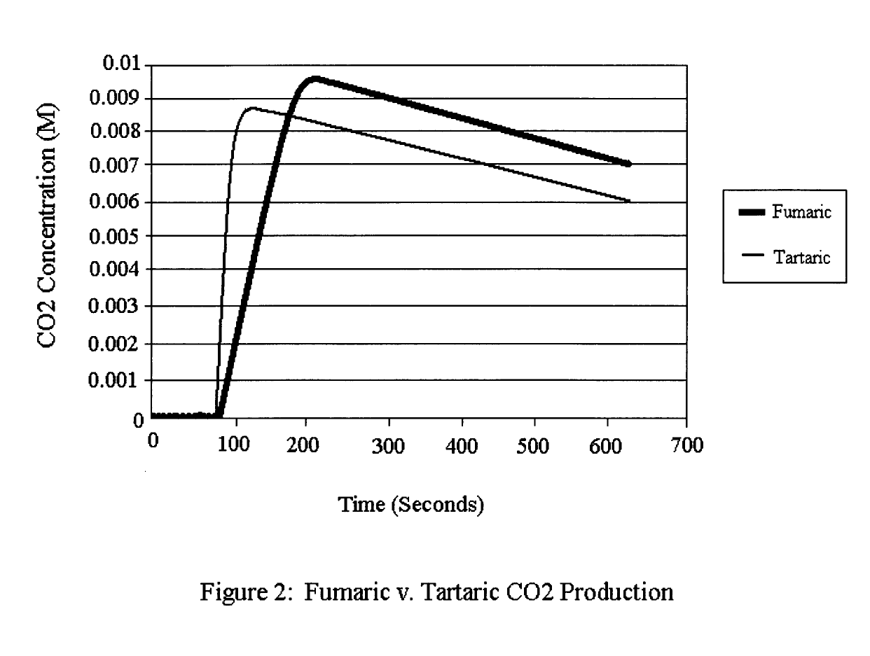

FIG. 2 illustrates a comparison graph showing the response of carbon dioxide production for fumaric and tartaric acid. After approximately 80 seconds of initial readings with the carbon dioxide ion selective electrode, an effective amount of tartaric acid was combined with a sample of carbonate solution at a concentration of 0.01 Molar and at 120 degrees Fahrenheit. A maximum level of carbon dioxide production occurred almost immediately and maxed out at approximately 0.0085M. With fumaric acid as the acidulent, the carbon dioxide reached a maximum concentration of 0.0095 M within about 120 seconds of adding the acid.

Tartaric acid is a closer relative to fumaric acid than citric acid. Like fumaric acid, tartaric acid is a diprotic acid with very similar acid strengths for each acidic proton. The main characteristic of these acids is their difference in water solubility. Fumaric acid is about two hundred time less soluble than tartaric acid in water at room temperature.

Using fumaric acid as the acidulent, the nearly two minute delay in maximum carbon dioxide level production will allow a user to mix the cleaning solution in a single container, with hot water, and cap the container without losing a great deal of carbonation.

In practice, 227 grams of fumaric acid is admixed to 190 grams of sodium carbonate, and mixed with five gallons of hot water, around 120 degrees Fahrenheit. The amounts of fumaric acid and sodium carbonate may be increased or decreased approximately five to ten grams. Similarly, 252 grams of adipic acid is admixed with 165 grams of sodium carbonate and mixed with five gallons of hot water, around 120 degrees Fahrenheit. The amounts of adipic acid and sodium carbonate may be increased or decreased approximately five to ten grams.

It is understood that the above-described arrangements are only illustrative of the application of the principles of the present invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, it is envisioned that other additives commonly found in commercial cleaning compositions may be added without departing from the scope of this invention provided they do not interfere with the interaction of the acids and carbonates and the creation of carbon dioxide. These include, but are not limited to, bleaches, optical brighteners, fillers, fragrances, antiseptics, germicides, dyes, stain blockers, preservatives, and similar materials.

It is also envisioned that the components (carbonate, acid, and water) of the cleaning composition may be applied to the textile simultaneously, e.g. mixed immediately before application, or during application. In the alternative the components of the cleaning composition may be applied, and thus mixed, in any desired order. For example, a solution of acid can be applied directly on the textile followed by the carbonate solution. Alternatively, the carbonate solution could be sprayed first and then the solution containing the acid. Either procedure works well because solutions with a pH which is not neutral tend to clean much better than those that are neutral.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An internally carbonated aqueous cleaning composition for textiles comprising:
about 20 to 60%, in percent by weight, of at least one carbonate salt;
about 20 to 60%, in percent by weight, of at least one acid, the acid having a solubility less than two grams per 100 grams of water at about twenty five degrees Celsius; and
wherein the carbonate salt and the acid are admixed in a single container such that when an aqueous medium is added to the container, the carbonate salt, the acid, and the aqueous medium react to produce carbon dioxide.

2. The cleaning composition of claim 1, wherein the composition comprises, in percent by weight:
about 40 to 60% acid; and
about 35 to 50% carbonate salt.

3. The cleaning composition of claim 1, wherein the solid acid is a member selected from the group consisting of fumaric acid and adipic acid.

4. The cleaning composition of claim 1, wherein the carbonate salt is a member selected from the group consisting of sodium carbonate, sodium percarbonate, sodium bicarbonate, lithium carbonate, lithium percarbonate, lithium bicarbonate, potassium carbonate, potassium percarbonate, potassium bicarbonate, ammonium carbonate, sodium sesquicarbonate, potassium sesquicarbonate, lithium sesquicarbonate, and ammonium sesquicarbonate, and ammonium bicarbonate.

5. The cleaning composition of claim 1, wherein the acid is fumaric acid.

6. The cleaning composition of claim 1, wherein the aqueous medium is water.

7. The cleaning composition of claim 1, wherein the aqueous medium is added to the carbonate salt and the acid at a temperature above thirty two degrees Celsius.

8. The cleaning composition of claim 1, wherein the aqueous medium is added to the carbonate salt and the acid at a temperature above thirty two degrees Celsius.

9. The composition of claim 1, wherein the composition comprises, in percent by weight, about 40 to 60% acid and about 35 to 50% carbonate salt, such that when the composition is mixed with the aqueous medium to form a solution, the composition concentration resulting from the carbonate salt and acid in the solution is between about 0.5 to 3%.

10. A method of cleaning textile fibers comprising the steps of:
applying to the fibers, an internally-carbonating cleaning composition, the composition being prepared by admixing:
20 to 60%, in percent by weight, a carbonate salt; and
20 to 60%, in percent by weight, an acid with a solubility less than two grams per 100 grams of water at twenty five degrees Celsius; and
wherein when the carbonate salt and the acid are mixed in an aqueous medium, the carbonate salt and acid react to produce carbon dioxide.

11. The method according to claim 10, wherein the composition is prepared by admixing, in percent by weight:
about 40 to 60% acid; and
about 35 to 50% carbonate salt.

12. The method of claim 10, wherein the acid is a member selected from the group consisting of fumaric acid and adipic acid.

13. The method of claim 10, wherein the carbonate salt is a member selected from the group consisting of sodium carbonate, sodium percarbonate, sodium bicarbonate, lithium carbonate, lithium percarbonate, lithium bicarbonate, potassium carbonate, potassium percarbonate, potassium bicarbonate, ammonium carbonate, sodium sesquicarbonate, potassium sesquicarbonate, lithium sesquicarbonate, and ammonium sesquicarbonate, and ammonium bicarbonate.

14. The method of claim 10, wherein the acid is fumaric acid.

15. The method of claim 10, wherein the carbonated cleaning solution is applied to the textile as a spray.

16. The method of claim 10, wherein the aqueous medium is water.

17. The method of claim 16, wherein the water is added at a temperature above thirty two degrees Celsius.

18. The method of claim 16, wherein the water is added at a temperature above forty eight degrees Celsius.

19. The method of claim 10, wherein the composition is prepared by admixing, in percent by weight, about 40 to 60% acid and about 35 to 50% carbonate salt, such that when the composition is mixed with the aqueous medium to form a solution, the composition concentration resulting from the carbonate salt and acid in the solution is between about 0.5 to 3%.

20. The method of claim 10, further comprising the steps of:
applying the cleaning composition to a textile; and
removing the cleaning composition from the textile.
